(19) United States
(12) Patent Application Publication
(10) Pub. No.: US 2023/0054913 A1
(43) Pub. Date: Feb. 23, 2023

(54) HAIRDRESSING SCISSORS

(71) Applicant: Jae Hong PARK, Seoul (KR)

(72) Inventors: Jae Hong PARK, Seoul (KR); Sang Hyub LEE, Seoul (KR)

(21) Appl. No.: 17/607,977

(22) PCT Filed: Apr. 28, 2020
(86) PCT No.: PCT/KR2020/005553

§ 371 Date: Oct. 19, 2022

(30) Foreign Application Priority Data
Apr. 30, 2019 (KR) 10-2019-0050524

(51) Int. Cl. B26B 13/24; B26B 13/08; B26B 13/28

(52) U.S. Cl. CPC B26B 13/24; B26B 13/08; B26B 13/28

(57) ABSTRACT

The present invention relates to hairdressing scissors for preventing hair or pet fur from flying by attaching a clamp blade to an upper blade of the hairdressing scissors.

According to an exemplary embodiment of the present invention, hairdressing scissors, in which an upper scissor body having an upper blade formed on one side and a handle formed on the other side and a lower scissor body having a lower blade formed on one side and a handle formed on the other side are rotatably coupled to each other by a hinge shaft, further include a clamp blade attached to the upper end of the inner surface of the upper blade by a joining member so as to rotate with the upper blade, wherein the clamp blade has a length longer than a width direction length of the upper blade so as to come in contact with the hair prior to the upper blade, and the joining member has a predetermined thickness so that the lower blade is able to rotate between the upper blade and the clamp blade.

### TECHNICAL FIELD

The present invention relates to hairdressing scissors. More particularly, the present invention relates to hairdressing scissors for preventing hair from flying by attaching a clamp blade to an upper blade of the hairdressing scissors.

### BACKGROUND ART

In general, scissors have a pair of scissor bodies hinged to each other in the shape of X, and each scissor body has a scissor blade formed on one side and a handle formed on the other side. If handles are opened by putting fingers into the handles, scissor blades facing each other will be opened, and if the handles are closed, the scissor blades facing each other are closed, thereby enabling easy cutting of an object to cut by the principle of the lever.

The hairdressing scissors include cutting scissors formed with smooth blades to be used to cut hair in a predetermined length and thinning scissors formed with comb-shaped grooves on one of a pair of scissor blades so as to thin hair out by cutting a part of the hair, in addition to double-edged thinning scissors formed with comb-shaped grooves formed on both sides of the pair of scissor blades.

However, during hairdressing stages, there are cases that hair needs to be trimmed due to some of the hair of customers sticking out or poorly organized even at a final stage after shampoo.

In addition, as the population raising pets is increasing recently, pets are groomed by experts in pet grooming salons, but it is hard to visit often since pets are very stressed and cost is expensive, such that there are many cases that hair sticking out in the middle is trimmed at home.

In such a case, the hair or dog fur cut by scissors falls to the floor directly and is scattered or attached to the body of customers, workers, or dog's body, causing discomfort or inconvenience such that there is a problem that the hair needs to be removed very carefully.

The above information disclosed in this Background section is only for enhancement of understanding of the background of the invention, and therefore it may contain information that does not form the prior art that is already known in this country to a person of ordinary skill in the art.

### DISCLOSURE

### Technical Problem

Accordingly, the present invention has been made in an effort to solve the above problems, and an exemplary object of the present invention is to provide hairdressing scissors having advantages of preventing hair or pet fur from being separated by attaching a clamp blade to an upper blade of the hairdressing scissors to make the clamp blade first come in contact with hair or pet fur and fixing the hair or pet fur between the clamp blade and a lower blade.

### Technical Solution

According to an exemplary embodiment of the present invention to achieve the object, hairdressing scissors, in which an upper scissor body having an upper blade formed on one side and a handle formed on the other side and a lower scissor body having a lower blade formed on one side and a handle formed on the other side are rotatably coupled to each other by a hinge shaft, further include a clamp blade attached to an upper end of an inner surface of the upper blade by a joining member so as to rotate with the upper blade, wherein the clamp blade has a length longer than a width direction length of the upper blade so as to come in contact with the hair prior to the upper blade, and the joining member has a predetermined thickness so that the lower blade is able to rotate between the upper blade and the clamp blade.

Protrusions and depressions are formed at a lower end of an inner surface of the clamp blade to come in contact with hair and fix it to an outer surface of the lower blade, wherein the protrusion and depression having a trapezoid shape have an inclined part having the same inclination as a blade end surface of the lower blade to slide on the blade end surface; and a straight line part connected to the inclined part.

The joining member is an elastic material so that the straight line part is able to come in contact with the outer surface of the lower blade as the inclined part slides along the blade end surface of the lower blade when cutting with the scissors.

A plurality of the joining members are disposed by being spaced apart at regular intervals along an upper end of the inner surface of the upper blade so that air may flow in between the upper blade and the clamp blade.

The clamp blade is made of a transparent plastic material.

A reinforcing member is further attached on the outer surface of the clamp blade to reinforce durability of the clamp blade.

The hairdressing scissors are thinning scissors on which grooves are regularly engraved on at least one of the upper blade and the lower blade.

According to another exemplary embodiment of the present invention, the hairdressing scissors, in which an upper scissor body having an upper blade formed on one side and a handle formed on the other side and a lower scissor body having a lower blade formed on one side and a handle formed on the other side are rotatably coupled to each other by a hinge shaft, further include a clamp blade including a blade part disposed under the lower end of the upper blade and having a bar shape; and first and second connection parts connected to both ends of the upper blade from both ends of the blade part, respectively, wherein the first connection part and the second connection part are attached to both ends of the upper blade by the joining member, and the joining member has a predetermined thickness so that the lower blade is able to rotate between the upper blade and the clamp blade.

On the inner surface of the blade part, protrusions and depressions in a trapezoid shape are formed in the direction toward the inner surface of the upper blade from the blade part, wherein the protrusion and depression may have an inclined part having the same inclination as a blade end surface of the lower blade so as to slide on the blade end surface of the lower blade; and a straight line part connected to the inclined part.

The joining member is made of an elastic material so that the straight line part is able to come in contact with the outer surface of the lower blade as the inclined part slides on the blade end surface of the lower blade when cutting with the scissors.

The clamp blade is made of a transparent plastic material.

### Advantageous Effects

As described above, according to an exemplary embodiment of the present invention, it is possible to prevent hair that is cut and falls off during hairdressing from flying by attaching a clamp blade to existing hairdressing scissors.

In addition, by fixing the cut hair between the clamp blade and a lower blade of the hairdressing scissors to throw away the hair in a trash can by opening the hairdressing scissors, it is unnecessary to separately remove or clean the hair while not giving discomfort to finishing customers, workers, or pets, thereby providing users with convenience.

In addition, by using the clamp blade made of a transparent material, it is possible to see hair or pet fur being cut during hairdressing such that the risk of cutting hair or pet fur in the wrong length may be reduced, and visual interest may be felt as well.

### DESCRIPTION OF THE DRAWINGS

FIG. 1 is a front view of hairdressing scissors according to an exemplary embodiment of the present invention.

FIG. 2 and FIG. 3 are drawings showing a state in which a clamp blade is attached to an upper blade of hairdressing scissors according to an exemplary embodiment of the present invention.

FIG. 4 is a side view of hairdressing scissors according to the present invention exemplary embodiment.

FIG. 5 is a cross-sectional view of the hairdressing scissors along line A-A of FIG. 1.

FIG. 6 to FIG. 9 are drawings showing a process of cutting hair or dog fur using hairdressing scissors according to an exemplary embodiment of the present invention.

FIG. 10 is a drawing showing a clamp blade according to another exemplary embodiment of the present invention.

FIG. 11 is a drawing showing the application of a clamp blade according to an exemplary embodiment of the present invention to double-edged thinning scissors.

### MODE FOR INVENTION

An exemplary embodiment of the present invention will hereinafter be described in detail with reference to the accompanying drawings.

The term “inner surface” used in the specification and claims refers to a surface on which a pair of scissor blades comes in contact with each other to cut an object to be cut, and the term “outer surface” refers to a surface on which a pair of scissor blades do not come in contact with each other.

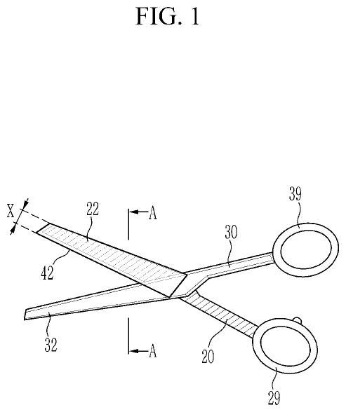

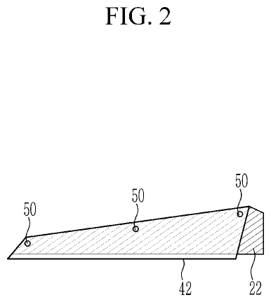

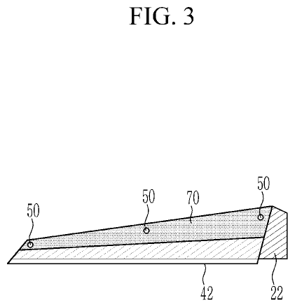

FIG. 1 is a front view of hairdressing scissors according to an exemplary embodiment of the present invention, and FIG. 2 and FIG. 3 are drawings showing a state in which a clamp blade is attached to the hairdressing scissors according to an exemplary embodiment of the present invention.

Referring to FIG. 1 and FIG. 2, a hairdressing scissors 10 include an upper scissor body 20 having an upper blade 22 formed on one side and a handle 29 formed on the other side and a lower scissor body 30 having a lower blade 32 formed on one side and a handle 39 formed on the other side, wherein the upper scissor body 20 and the lower scissor body 30 are hinge-coupled. The hairdressing scissors 10 may be conventional cutting scissors formed with a pair of scissor blades and may cut hair or pet fur by rotating with each other.

A clamp blade 42 is further attached to the upper blade 22 of the hairdressing scissors 10 by a joining member 50, so that the upper blade 22 and the clamp blade 42 rotate together when cutting with the scissors. The clamp blade 42 has the same shape as the shape of the upper blade 22 but has a length longer than the width direction (X) length of the upper blade 22.

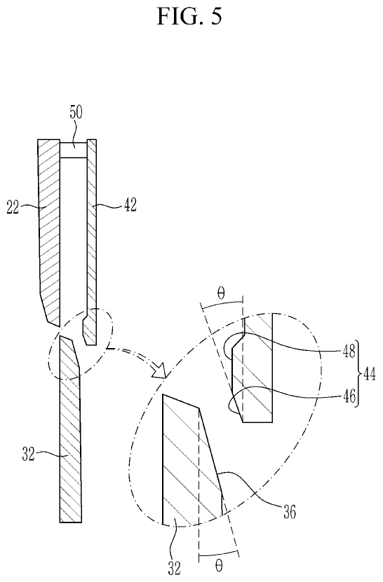

Accordingly, when cutting hair or pet fur such as dog fur, the clamp blade 42 comes in contact with the hair prior to the upper blade 22. Hair fixed between the clamp blade 42 and the upper blade 22 is separated by opening the hairdressing scissors 10 again, and a detailed description will be given in FIG. 5.

Meanwhile, referring to FIG. 3, on an outer surface of the clamp blade 42, a reinforcing member 70 may be further attached to reinforce joining durability with the upper blade 22 of the clamp blade 42 or durability against the tension generated by sliding with respect to the lower blade 32.

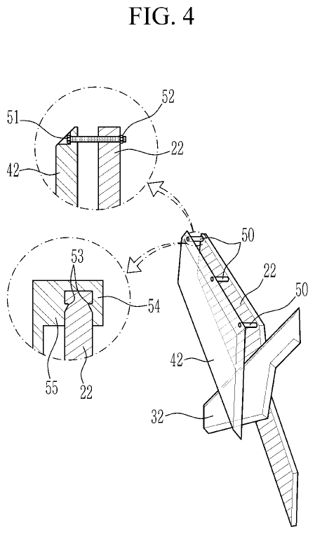

FIG. 4 is a side view of hairdressing scissors according to the present invention exemplary embodiment.

Referring to FIG. 4, the clamp blade 42 is adhered to an upper end of the inner surface where the upper blade 22 and the lower blade 32 come in contact with each other by a joining member 50. In addition, the joining member 50 has predetermined thickness so that the lower blade 32 is able to rotate between the clamp blade 42 and the upper blade 22, and thus a specific space exists between the clamp blade 42 and the upper b lade 22. That is, the thickness of the joining member 50 varies depending on the thickness of the lower blade 32.

The clamp blade 42 may be made of a transparent plastic material. Accordingly, by attaching the clamp blade 42, which is longer than a width direction length of the upper blade 22, to the upper blade 22, it is possible to reduce the risk of cutting the length of hair shorter or longer than planned as a part that dog fur is to be cut is not predicted. In addition, visual interest may be given since cutting of hair or pet fur can be seen.

Meanwhile, the joining members 50 may be disposed by being spaced apart at regular intervals along the upper end of the inner surface of the upper blade 22. In other words, a space is created between the joining members 50 so that air is able to be flowed in and out between the upper blade and the clamp blade.

Therefore, while the hair or pet fur fixed between the clamp blade 42 and the upper blade 22 may be generally stick to the scissor blade due to static electricity when opening hairdressing scissors, it is possible to make the hair be well separated compared to the case that the joining members 50 are entirely disposed along the upper end of the inner surface of the upper blade by the flow of air.

Meanwhile, the joining member 50 may be formed by using an adhesive or by welding, and may perform joining with a rivet 51 and a screw 52 to increase durability, joining in a snap-fit manner with respect to the upper blade 22 inexpensively and easily by using fitting parts 54 and 55 having a snap coupling part 53, or fitting and coupling by forming a protrusion 56 at a lower portion of the clamp blade 42 and forming a groove 57 in the upper blade without using an adhesive.

FIG. 5 is a cross-sectional view of hairdressing scissors along line A-A of FIG. 1.

Referring to FIG. 5, the clamp blade 42 is attached to the upper end of the inner surface of the upper blade 22 by the joining member 50. The clamp blade 42 has a length longer than the width direction (X) length of the upper blade 22.

In addition, when trimming hair or pet, protrusions and depressions 44 are formed on the lower end of the inner surface of the clamp blade 42 in order to minimize the area that hair or pet fur to be cut comes in contact between the clamp blade 42 and the lower blade 22.

When the hairdressing scissors are opened again by the protrusions and depressions 44, the cut hair may be easily removed by minimizing the contact area between the clamp blade 42 and the cut hair.

The protrusions and depression 44 have a trapezoid shape convex from the clamp blade 42 toward the upper blade 22 and have an inclined part 46 and a straight line part 48. The inclined part 46 is a side in contact with a blade end surface 36 of the lower blade 32 and has the same inclination 8 as the inclination 8 of the blade end surface 36.

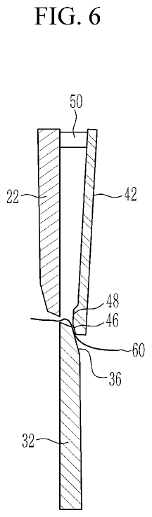

FIG. 6 to FIG. 9 are drawings showing a process of cutting hair or pet fur using hairdressing scissors according to an exemplary embodiment of the present invention.

Referring to FIG. 6, hair or pet fur is positioned between the upper blade 22 and the lower blade 32 by opening the hairdressing scissors, the lower blade 32 moves between the upper blade 22 and the clamp blades 42 by closing the scissors, and the inclined part 46 of the clamp blades 42 comes into contact with the blade end surface 36 of the lower blade 32.

Since the width direction length of the clamp blade 42 is longer than the width direction length of the upper blade 22, hair 60 comes in contact with the clamp blade 42 prior to the upper blade 22, and the clamp blade 42 presses the hair 60 with the lower blade 32.

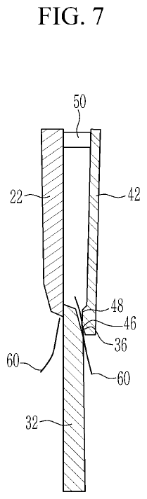

Referring to FIG. 7, as the scissors are closed, the inclined part 46 slides on the blade end surface 36 while pressing the hair or pet fur 60.

In addition, the hair or pet fur 60 is cut as the upper blade 22 and the lower blade 32 come into contact. The cut hair or pet fur 60 is fixed to the clamp blade 42 without falling to the floor while the inclined part 46 of the clamp blade 42 slides along the blade end surface 36 of the lower blade 32.

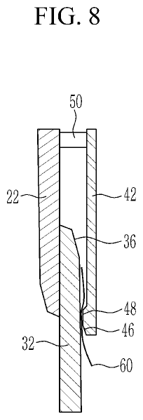

Referring to FIG. 8, after that, the clamp blade 42 is supported on the outer surface of the lower blade 32 as the straight line part 48 slides along the outer surface of the lower blade 32. Accordingly, the cut hair or pet fur 60 is flowed into a space between the clamp blade 42 and the upper blade 22 along the outer surface of the lower blade 32 and fixed to the outer surface of the lower blade 32.

That is, since the cut hair or pet fur 60 do not fall on the floor, it is possible to prevent the cut hair 60 from flying.

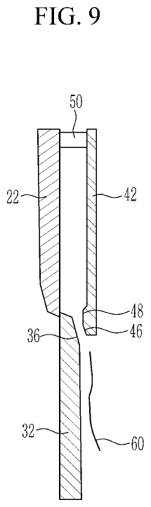

Referring to FIG. 9, when opening the scissors at a place where the cut hair 60 is thrown away such as a trash can, the clamp blade 42 and the lower blade 32 do not come in contact with each other, so that the hair 60 falls off without being fixed to the clamp blade 42.

Accordingly, a user may throw away the cut hair or pet fur at a desired place by opening the scissors. Therefore, it is possible to provide users with convenience without giving customers or pets discomfort due to the cut hair or fur or without need for workers to remove or separately process the hair or fur.

Meanwhile, the clamp blade 42 is in a state parallel to the upper blade 22, is pressed toward the upper blade 22 when the scissors are closed, and returns to a state parallel to the upper blade 22 when the scissors are opened again. Accordingly, the joining member 50 may be made of an elastic material.

As the joining member 50 is made of the elastic material as described above, it is desirable that the clamp blade 42 may maintain the pressure so that the clamp blade 42 is able to press and properly hold the cut hair or fur 60 onto the outer surface of the lower blade 32.

For this purpose, the clamp blade 42 is controlled to be vertically separated, and it is also possible to increase the pressure with the clamp blade 42 by making the thickness of the lower blade 32 thicker than that of the clamp blade 42.

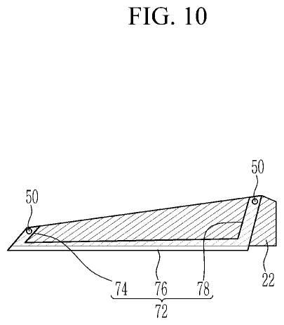

FIG. 10 is a drawing showing a clamp blade according to another exemplary embodiment of the present invention.

Referring to FIG. 10, the clamp blade 72 is formed of a blade part 76 disposed under the lower end of the upper blade 22 and having a bar shape; and a first connection part 74 and a second connection part 78 respectively connected from both ends of the blade part 76 to both ends of the upper blade 22.

The first connection part 74 and the second connection part 78 are attached to the upper blade 22 by the joining member 50. The blade part 76 is disposed below the lower end of the upper blade 22 so as to come in contact with the hair prior to the upper blade 22 when cutting with scissors. Protrusions and depressions are formed on the inner surface of the blade part 76 in the same manner as the clamp blade 42 described above, and the description of the protrusions and depressions and the description of the joining member 50 will be omitted as previously described.

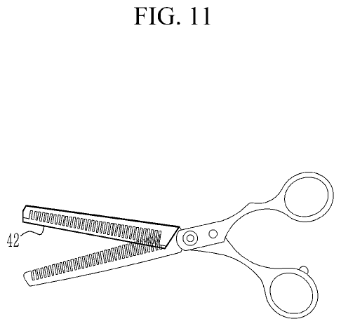

FIG. 11 is a drawing showing the application of the clamp blade according to an exemplary embodiment of the present invention to double-edged thinning scissors.

The clamp blade 42 according to an exemplary embodiment of the present invention may be attached to an upper blade of double-edged thinning scissors as shown in FIG. 11 and also to an upper blade of single-edged thinning scissors in order to first come in contact and fix the hair or fur that is cut during hairdressing.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

As described above, according to an exemplary embodiment of the present invention, it is possible to prevent hair that is cut off and falls during hairdressing from flying by attaching a clamp blade to existing hairdressing scissors.

In addition, by fixing the cut hair between the clamp blade and a lower blade of the hairdressing scissors to throw away the hair in a trash can by opening the hairdressing scissors, it is unnecessary to separately remove or clean the hair while not giving discomfort to finishing customers, workers, or pets, thereby providing users with convenience.

In addition, by using the clamp blade made of a transparent material, it is possible to see hair or pet fur being cut during hairdressing such that the risk of cutting hair or pet fur in the wrong length may be reduced, and visual interest may be felt as well.

1. Hairdressing scissors in which an upper scissor body having an upper blade formed on one side and a handle formed on the other side and a lower scissor body having a lower blade formed on one side and a handle formed on the other side are rotatably coupled to each other by a hinge shaft, further comprising a clamp blade attached to an upper end of an inner surface of the upper blade by a joining member so as to rotate with the upper blade,
wherein the clamp blade has a length longer than a width direction length of the upper blade so as to come in contact with hair or pet fur prior to the upper blade, and
the joining member has a predetermined thickness so that the lower blade is able to rotate between the upper blade and the clamp blade.

2. The hairdressing scissors of claim 1, wherein:
protrusions and depressions are formed at a lower end of an inner surface of the clamp blade to come in contact with hair or pet fur and fix it to an outer surface of the lower blade, and
wherein the protrusion and depression having a trapezoid shape have an inclined part having the same inclination as a blade end surface of the lower blade to slide on the blade end surface; and
a straight line part connected to the inclined part.

3. The hairdressing scissors of claim 2, wherein:
the joining member is an elastic material so that the straight line part is able to come in contact with the outer surface of the lower blade as the inclined part slides along the blade end surface of the lower blade when cutting with the scissors.

4. The hairdressing scissors of claim 3, further comprising:
a plurality of the joining members,
wherein the plurality of joining members are disposed by being spaced apart at regular intervals along an upper end of the inner surface of the upper blade so that air is able to be flowed in between the upper blade and the clamp blade.

5. The hairdressing scissors of claim 4, wherein:
the clamp blade is made of a transparent plastic material.

6. The hairdressing scissors of claim 5, wherein:
on the outer surface of the clamp blade, a reinforcing member is further attached to reinforce durability of the clamp blade.

7. The hairdressing scissors of claim 6, wherein:
the hairdressing scissors are thinning scissors on which grooves are regularly engraved on at least one of the upper blade and the lower blade.

8. Hairdressing scissors in which an upper scissor body having an upper blade formed on one side and a handle formed on the other side and a lower scissor body having a lower blade formed on one side and a handle formed on the other side are rotatably coupled to each other by a hinge shaft,
further comprising a clamp blade comprising: a blade part disposed under the lower end of the upper blade and having a bar shape; and first and second connection par is connected to both ends of the upper blade from both ends of the blade part, respectively,
wherein the first connection part and the second connection part are attached to both ends of the upper blade by the joining member, and
the joining member has a predetermined thickness so that the lower blade is able to rotate between the upper blade and the clamp blade.

9. The hairdressing scissors of claim 8, wherein:
on the inner surface of the blade part, protrusions and depressions in a trapezoid shape are formed in the direction of the inner surface of the upper blade from the blade part,
wherein the protrusion and depression have an inclined part having the same inclination as a blade end surface of the lower blade so as to slide on the blade end surface of the lower blade; and a straight line part connected to the inclined part.

10. The hairdressing scissors of claim 9, wherein:
the joining member is an elastic material so that the straight line part is able to come in contact with the outer surface of the lower blade as the inclined part slides on the blade end surface of the lower blade when cutting with the scissors.

11. The hairdressing scissors of claim 10, wherein:
the clamp blade is made of a transparent plastic material.
